(19) United States
(12) Patent Application Publication
(10) Pub. No.: US 2009/0246358 A1
(43) Pub. Date: Oct. 1, 2009

(54) CONDUCTIVE SILVER DISPERSIONS AND USES THEREOF

(75) Inventor: Jurjen F. Winkel, Cambridgeshire (GB)

Correspondence Address: EASTMAN KODAK COMPANY;PATENT LEGAL STAFF, 343 STATE STREET, ROCHESTER, NY, 14650-2201, US

(73) Assignee: EASTMAN KODAK COMPANY, ROCHESTER (NY)

(21) Appl. No.: 11/721,289

(22) PCT Filed: Nov. 9, 2005
(86) PCT No.: PCT/GB05/04310

§ 371 Date: Jun. 8, 2007

(30) Foreign Application Priority Data
Nov. 12, 2004 (GB) 042164.9

(51) Int. Cl. H01B 1/02; B05D 5/12

(52) U.S. Cl. 427/98.5; 252/520.3

(57) ABSTRACT

Silver particles having controlled and predetermined properties of size, morphology and size distribution for use in manufacturing of conductive inks, conductive fillers and/or conductive coatings are provided by forming a dispersion of silver halide particles in a carrier medium such as gelatin and treating the dispersion such that the silver halide particles are converted into the desired silver particles.

### FIELD OF THE INVENTION

The present invention relates to silver dispersions and the use thereof as conductive materials, particularly conductive inks, conductive tracks, and electronic circuit boards and devices utilising such conductive inks and conductive tracks and to methods for manufacturing the same. The invention is particularly concerned with the preparation of such silver dispersions whereby the conductivity, particle size, size distribution, morphology and other properties of such a silver dispersion can be beneficially controlled.

### BACKGROUND OF THE INVENTION

In the imaging, lighting, display and electronics industries, it is predicted that in order to meet consumer demands, and fuelled by industry competitiveness, electronics products will require to be increasingly durable, thin, lightweight and of low cost. In a growing market where consumers are demanding more from portable electronic devices and displays such as mobile phones, laptop computers, etc., flexible displays and electronics have the potential to eliminate the rigid constraints of traditional flat panel displays and electronics products. The goal in displays and electronics is to produce thin, lightweight, flexible devices and displays with achievable power requirements at a minimal cost.

Recent developments in the printing industry have led to increased focus on functional inks, especially conductive inks, with potential applications for electronics in the form of RFID tags, printed circuits, backplane structures for photovoltaic and display devices and in the manufacture of electronics devices. The use of printing methods to apply conductive inks to a substrate further promotes the possibility of using a flexible substrate upon which conductive tracks can be printed to manufacture electronics component at high volume and low cost.

Dispersions of conductive particles that may be used in inks may comprise mixtures of highly conductive particles or flakes including copper, silver coated copper, silver, platinum and gold among others, as is necessary to achieve the necessary conductivity using a relatively small amount of the conductive material as compared with traditional electronics methods. In particular, silver particles or flakes find utility in conductive inks, conductive adhesives and RF/EM shielding additives for plastics and coatable conductors.

Several methods of utilising silver dispersions in conductive inks and coatable conductors to be applied to flexible or rigid substrates are known.

U.S. Pat. No. 6,379,745 discloses a printable composition for applying to temperature-sensitive substrates and curing to form high electrical conductivity traces at temperatures that the substrates (including rigid, glass-reinforced expoy laminates and polyimide films for flexible circuits) can withstand. The composition can be applied by any convenient printing technology including screen printing, stenciling, gravure printing, impression printing, offset printing and ink-jet printing. The composition described comprises a metal powder mixture and a reactive organic medium. The metal powder mixture is a mixture of at least two types of metal powders: metal flakes with a major diameter of approximately 5 μM and a thickness to diameter ratio of 10 or more; and colloidal or semi-colloidal metal powders with mean diameters less than about 100 nm which are not aggregated to any great degree. The metals are typically copper or silver. The reactive organic medium can consist of any metallo-organic compound which is readily decomposable to the corresponding metal, e.g. metal soaps.

U.S. Pat. No. 6,797,772 relates to storage-stable silver-filled organosiloxane compositions yielding cured electrically conductive elastomers that retain their electrical properties for extended periods of time. The compositions overcome prior art problems such as poor curability of electrically conductive silicone rubber compositions and declining adhesion and affinity between cured silicone elastomer and silver particles by the treatment of finely divided silver particles with an organosilicon compound prior to combining the particles with the other ingredients of the curable organosiloxane composition. The conductive silicone rubber composition resulting comprises a polyorganosiloxane containing at least two alkenyl radicals per molecule, an organohydrogensiloxane containing at least two silicon-bonded hydrogen in each molecule, finely divided silver particles and a platinum-containing hydrosilation catalyst to promote curing of the composition.

U.S. Pat. No. 6,322,620 describes a screen printable thermoset conductive ink for use in through-hole interconnections or similar electronic applications. The thermoset conductive ink described comprises a thermal curable resin system having an admixture of an epoxy resin, a cross-linking agent and a catalyst, an organic solvent and about 50-90 wt % of an electrically conductive material such as silver, copper, silver-coated copper, but especially silver flakes. The thermoset conductive ink was reported to have high electrical conductivity and to be stable at high temperatures for a short time once cured, to have good cohesion strength and good solvent resistance.

U.S. Pat. No. 6,558,746 relates to a coating composition for producing electrically conductive coatings for electromagnetic shielding (EMI screening) of electronic devices such as personal computers and portable telephones amongst other things, the composition comprising one or more conductive pigments and an organic binder which is a copolymer dispersible in water and based on (meth)acrylate and silylated unsaturated monomers and an aqueous solvent. Conductive coatings with excellent adhesive strength, mechanical resistance and solvent resistance can be obtained. The preferred conductive pigments are silver flakes and copper flakes.

WO-A-03/068874 discloses a conductive ink for gravure or flexographic printing of RFID tags on packages and the like, which conductive ink comprises a carboxylic acid or anhydride-functional aromatic vinyl polymer and an electrically conductive material that may be a particulate or a flake material, especially a conductive flake material having an aspect ratio of at least 5:1. The conductive particulate material may be a conductive metal oxide such as antimony tin oxide or indium tin oxide, or may be a metal such as silver, aluminium or copper. The ink preferably also comprises a conductive flake material which is typically graphite, carbon fibre, mica coated with antimony or indium tin oxide, metallic flakes such as silver, copper or aluminium flakes having an aspect ratio of at least 5:1 preferably 10:1 to 50:1.

U.S. Pat. No. 6,517,931 describes a method of using a conductive silver ink in the manufacture of multi-layer ceramic capacitor (MLC) devices. The silver ink described typically comprises at least a high purity silver powder having an average particle size of up to 1 μm; an inhibitor such as a barium titanate based material; and a vehicle comprising a mixture of resin (e.g. ethyl cellulose) and solvent (e.g. toluene/ethanol mixture). According to U.S. Pat. No. 6,517,931, the ink is screen printed to a desired pattern on dielectric green tapes which are stacked to form a registry, laminated under pressure and then fired to form the MLC device.

WO-A-97/48257 describes the lithographic printing of an electrically conductive ink onto a substrate in the manufacture of various electrical components such as resistors, capacitors and, in particular, circuit boards with low complexity circuits as substitutes for conventional copper clad circuit boards. The preferred electrically conductive ink according to WO-A-97/48257 comprises metallic silver (e.g. about 80% w/w) of about 1 μm suspended in an organic resin such as alkyd resin. The ink is applied to a substrate such as gloss art paper, bond paper or a semi-synthetic or synthetic paper by lithographic printing in layers of about 5 μm. Adequate mechanical and electrical properties are achieved with the described conductive ink. It is suggested that to accommodate such small ink laydowns, the ink must exhibit a high electrical conductivity.

Particular problems with silver dispersions of the prior art include the amount of silver necessary to apply to a substrate to attain the necessary degree of conductivity, which will likely be a prohibitive cost as the overall cost of substrate and other components is reduced in the flexible electronics sector. Other such problems include the difficulty in attaining a high-resolution conductive track, especially through printing conductive inks, which limits the utility of conductive inks in manufacture of electronics to low complexity circuits and the like.

### PROBLEM TO BE SOLVED BY THE INVENTION

It is desirable to provide dispersions of silver particles with highly controlled particle size, shape and size distribution to meet the specific requirements of the intended utility in terms of conductivity, resolution, consistency and cost.

It is desirable to provide a method of manufacturing dispersions of silver particles or silver powders whereby the size, morphology and size distribution of the particles can be accurately controlled to meet those requirements.

It is further desirable to provide a conductive ink comprising silver particles, which has improved conductivity and is capable of providing improved resolution at a relatively low silver laydown and therefore at a reduced cost.

### SUMMARY OF THE INVENTION

According to a first aspect of the invention, there is provided a method of manufacturing a conductive ink, a conductive filler and/or a conductive coating, which conductive, ink, conductive filler and/or conductive coating comprises particles of silver for imparting conductivity, alone or in combination with another conductive material, said method comprising the steps of providing a dispersion of silver halide particles in a carrier medium; treating said dispersion of silver halide particles such that the silver halide particles are converted into silver particles to form a dispersion of silver particles in a carrier medium; and further processing the dispersion of silver particles in a carrier medium to form a conductive ink, a conductive filler and/or a conductive coating.

In a second aspect of the invention there is provided a conductive ink, a conductive filler or a conductive coating obtainable by the above method.

In a third aspect of the invention there is provided a conductive ink for ink-jet printing, said conductive ink comprising a dispersion of silver particles having silver particles with a cubic or tabular morphology, said dispersion having a size distribution with a coefficient of variation of up to 0.5.

In a fourth aspect of the invention there is provided a conductive ink for lithographic printing, said conductive ink comprising a dispersion of silver particles having silver particles with a largest dimension of up to 10 μM and a tabular morphology with an aspect ratio of at least 5:1.

In a fifth aspect of the invention there is provided a conductive filler comprising a dispersion of silver particles with a largest dimension of up to 10 μm and a tabular morphology with an aspect ratio of at least 5:1.

In a sixth aspect of the invention there is provided a conductive coating comprising a dispersion of silver particles with a largest dimension of up to 10 μm and a tabular morphology with an aspect ratio of at least 5:1.

In a seventh aspect of the invention there is provided a method of manufacturing a silver dispersion for use as or in the manufacture of a conductive ink, a conductive filler and/or a conductive coating, said method comprising the steps of providing a dispersion of silver halide particles in a carrier medium; and treating said dispersion of silver halide particles such that the silver halide particles are converted into silver particles to form a dispersion of silver particles in a carrier medium, said method characterised by the dispersion of silver particles having one or more of the following features:

A) a coated conductivity represented by a resistivity of up to 1000 ohms per square.

B) at least 50% tabular silver particles having an aspect ratio of at least 3:1; and

C) a size distribution of particles with a coefficient of variation of up to 0.4.

In an eighth aspect of the invention there is provided a dispersion of silver particles for use as or in the manufacture of conductive inks, conductive fillers and/or conductive coatings, said dispersion of silver particles comprising silver particles dispersed in a carrier medium in a concentration capable of imparting conductivity represented by a resistivity of 1000 ohms per square or less to inks, fillers and/or coatings formed therefrom, wherein the silver particles have a tabular morphology and an aspect ratio of at least 3:1 and/or the silver dispersion has a size distribution of silver particles with a coefficient of variation of up to 0.5.

In a ninth aspect of the invention there is provided a method of manufacturing an electronic circuit comprising the steps of applying a dispersion of silver particles as defined above to a substrate in a desired pattern of conductive tracks.

In a tenth aspect of the invention there is provided a use of silver halide particles in the manufacture of conductive inks, conductive fillers and/or conductive coating by treating the dispersion of silver halide particles such that the silver halide particles are converted to silver particles to form a dispersion of silver particles and forming therefrom a conductive ink, a conductive filler or a conductive coating.

In an eleventh aspect of the invention there is provided a use of factors controlling the size, size distribution and/or morphology of silver halide particles in generating dispersions of silver halide particles to control the respective size, size distribution and/or morphology of silver particles in a silver particle dispersion by treating a dispersion of silver halide particles such that it is converted into a dispersion of silver particles.

In a twelfth aspect of the invention there is provided a use of factors controlling the respective degrees of physical and chemical development of fogged silver halide to control the morphology of silver particles formed by treatment of the silver halide particles such that they undergo a fogging step and a developing step.

### ADVANTAGEOUS EFFECT OF THE INVENTION

The method of manufacturing a dispersion of silver and the conductive materials according to the invention enables specifically formulated silver dispersions depending upon the desired utility, physical requirements and cost-sensitivity. The method may be utilised to tightly control the particle size, size distribution, dimensions and morphology according to that required in order to maximise, for example, the conductivity of a conductive ink at the minimum laydown of silver.

### BRIEF DESCRIPTION OF THE DRAWINGS

FIG. 1 shows an SEM image at 5000 times magnification of 100% silver chloride cubic particles;

FIG. 2 show an SEM image at 5000 times magnification of cubic silver particles formed from the silver chloride particles of FIG. 1;

FIG. 3 shows an SEM image at 10,000 times magnification of 100% silver chloride tabular [100] particles;

FIG. 4 shows an SEM image at 10,000 times magnification of tabular silver particles formed from the silver chloride tabular [100] particles of FIG. 3;

FIG. 5 shows an SEM image at 10,000 times magnification of 100% silver chloride tabular [111] particles;

FIG. 6 shows an SEM image at 10,000 times magnification of tabular silver particles formed from the tabular [111] silver chloride particles of FIG. 5; and

FIG. 7 shows an SEM image at 5000 times magnification of silver particles formed from the silver chloride tabular [100] particles of FIG. 5, having been fogged with SnCl₂.

### DETAILED DESCRIPTION OF THE INVENTION

The method of the invention comprises manufacturing a silver dispersion in a carrier medium, which can be utilised in the manufacture of various components for use typically in the electronics, display and printing industries, amongst others. For example, the silver dispersions prepared according to the method of the present invention may be utilised in preparing conductive inks for use in printing conductive tracks on a circuit board substrate or other electronic device, as a conductive filler for use in RF shielding as in various electronic devices such as mobile phones and laptop computers, and as a coatable conductor whereby the silver dispersion may be coated onto a support to form a conductive layer or conductive tracks, e.g. in a circuit board or photovoltaic backplate.

According to the method of the invention, a dispersion of silver halide particles is provided in a carrier medium and treated such that the silver halide particles are converted into silver particles to form a dispersion of silver particles in a carrier medium. The dispersion of silver particles may then be subjected to one or more further steps in order to utilise the silver dispersion as a conductive ink, a conductive filler or to form a conductive coating, as will be described below.

The carrier medium utilised may be any suitable carrier in which silver halide particles may form a dispersion and in which it is possible to convert silver halide to silver particles. Preferably, the carrier medium is suitable for precipitating silver halide particles from silver ions and halide ions. Typically, the carrier medium utilised is any carrier medium used in the photographic arts in which photographic silver halide emulsions are formed. A suitable carrier medium may comprise, for example, one or more of naturally occurring hydrophilic colloids and gums such as gelatin (e.g., alkali-treated gelatin such as cattle bone or hide gelatin or acid treated gelatin such as pigskin gelatin), albumin, guar, xantham, acacia and chitosan and their derivatives, functionalised proteins, functionalised gums and starches, cellulose ethers, esters and their derivatives, such as hydroxyethyl cellulose, hydroxypropyl cellulose and carboxymethyl cellulose, sulfonated polyesters, polyvinyl oxazoline and polyvinyl methyloxazoline, polyoxides, polyethers, poly(ethylene imine), poly(acrylic acid), poly(methacrylic acid), n-vinyl amides including acrylamide polymers and polyvinyl pyrrolidone, polyethylene oxide, polyvinyl alcohol, poly(vinyl lactams), polyvinyl acetals, polymers of alkyl and sulphoalkyl acrylates and methacrylates, such as substituted and unsubstituted poly(hydroxyalkyl(meth)acrylates), hydrolysed polyvinyl acetates, polyamides, methacrylamide copolymers such as substituted and unsubstituted poly(hydroxyalkyl(meth)acrylamides) and poly(meth)acrylates and poly(meth)acrylamides optionally bearing poly(alkene oxide) substituents, latex copolymer, polyethylene glycols, polyglycidols and/or combinations of any of the above. Suitable carrier mediums preferably comprise a hydrophilic colloid such as, for example, a water-soluble polymer or copolymer including, but not limited to poly(vinyl alcohol), partially hydrolyzed poly(vinyl acetate-co-vinyl alcohol), hydroxyethyl cellulose, poly(acrylic acid), poly(1-vinylpyrrolidone), poly(sodium styrene sulfonate), poly(2-acrylamido-2-methane sulfonic acid) and polyacrylamide, or co-polymers of these polymers with hydrophobic monomers, but more preferably a gelatin or modified gelatin such as acetylated gelatin, phthalated gelatin, oxidized gelatin or diamine derivatized gelatin. The gelatin may be base-processed, such as lime-processed gelatin, or may be acid-processed, such as acid-processed ossein gelatin. More preferably the carrier medium is gelatin.

The silver halide may be any or a combination of silver halides. The silver halide dispersion may comprise one or more of silver chloride, silver bromide and silver iodide, but preferably it comprises silver chloride alone or in combination with silver bromide and/or silver iodide. More preferably, the silver halide dispersion comprises at least 50% silver chloride still more preferably at least 80% silver chloride, more preferably at least 90% silver chloride, such as from 95% to 98%, still more preferably at least 99.5% and most preferably it consists essentially of silver chloride and still more preferably comprises 100% silver chloride.

According to the present invention, the silver halide dispersion provided in a carrier medium, which is preferably gelatin, is treated such that the silver halide particles are converted into silver particles. This conversion can be effected by any suitable method by which silver halide converts to silver, but is preferably conducted by a highly efficient method whereby the vast majority of the particles can be converted in a relatively short time, but in a controlled manner such that some degree of control of the size and morphology of the silver particles can be effected.

Typically, the conversion of silver halide particles to silver particles comprises a two-step process. Firstly, the silver halide particles are “fogged” to generate silver halide particles in which some of the silver halide molecules have been reduced to silver atoms. Secondly, the fogged particles are “developed” using a developer composition in order to convert the silver halide particles into silver particles.

The step of fogging the silver halide particles can be carried out in any suitable manner, of which there are a number. For example, the silver halide particles may be fogged by treating the silver halide particles with one or more reducing agents, by exposing the silver halide particles to radiation to which they are sensitive, by adjusting the pH of the silver halide dispersions and/or by incorporating silver ions or a source of silver ions in the silver halide dispersion.

Suitable reducing agents for use in fogging silver halide particles include, for example, stannous chloride and DMAB (dimethyl borane).

Where the silver halide particles are fogged by exposure to a radiation source, it is preferred to use a light source of a wavelength to which the particles are sensitive. This method of fogging can be made much more efficient by utilising silver halide particles that have been spectrally sensitised. Any suitable method of spectral sensitisation may be used as are common in photographic silver halide emulsions. Suitable such methods of spectral sensitisation are described, for example, in Research Disclosure, Item 37038, February 1995, Sections I to V.

Silver ions may be used to fog the silver halide emulsion by, for example, adding excess of silver ions during precipitation of the silver halide particles or by incorporating a suitable silver ion source into the silver halide dispersion.

Where the silver halide particles are fogged by raising the pH of the dispersion of silver halide particles, it is preferred that the pH is raised to at least 9, typically in the range 9-14 and preferably to about 12. Optionally, the pH may be maintained at this level for a short period sufficient to cause at least some degree of fogging to occur, or it may be held for a more substantial period to ensure widespread fogging of the particles occurs.

Typically, the pH is raised by the addition of a base, such as sodium hydroxide solution, to the silver halide dispersion.

The step of developing the fogged silver halide particles may comprise any suitable development method. The developer composition comprises a component capable of causing the transformation of a silver halide particle that has been fogged into a silver particle. Typically, the development step involves treating the fogged silver halide particles with a developer composition or activating a dormant developer composition. Suitable such developer compositions include developers known for use in photographic (colour or black and white) development process and preferably comprises, for example, one or more of ascorbic acid, sodium erythorbate, hydroquinone and derivatives thereof. Preferred developer compositions comprise ascorbic acid, sugar type derivatives of ascorbic acid, stereoisomers, diastereomers, precursors of these acids and their salts, preferably ascorbic acid itself.

A dormant developer composition (or incorporated developer) is a developer composition, which is capable of causing the transformation of a fogged silver halide particle into a silver particle once activated. Suitable such dormant developer compositions include, for example, ascorbic acid when kept in solution at a pH of less than 7. Such a dormant developer composition may be activated by raising the pH of the composition.

At the onset of development, it is common for the pH of the dispersion of particles to become lowered (e.g. to less than pH 9) temporarily before returning to a higher pH again. Optionally, e.g. to maintain a high rate of development (especially when using a dormant developer composition that activates at a certain minimum pH), the dispersion may be treated, e.g. with a base such as sodium hydroxide solution, to counter that reduction and limit the reduction of, maintain or raise the pH of the dispersion, particularly during the first few minutes of development.

In one preferred embodiment, the fogging and the development steps of treating the silver halide particles are in effect a single step comprising raising the pH of the silver halide dispersion, which comprises a dormant developer composition that may be activated by raising the pH1. The step of raising the pH of the silver halide dispersion having the effect of fogging the silver halide particles and activating the developer composition.

Optionally, the developer composition further comprises a co-developer or development accelerator. Suitable such co-developers are disclosed in EP-A-0758646, EP-A-0528480 and U.S. Pat. No. 4,753,869 and include, for example, aminophenols such as methyl-p-aminophenol sulphate and phenyl-3-pyrozolidones or phenidones such as 1-phenyl-3-pyrazolidone, 1-phenyl-4-methyl-3-pyrazolidone, 1-phenyl-4,4′-dimethyl-3-pyrazolidone and 1-phenyl-4-methyl-4′-hydroxymethyl-3-pyrazolidone (HMMP). A preferred co-developer is HMMP. The phenyl-3-pyrozolidone or phenidone co-developers, especially HMMP, find particular utility alongside developers such as ascorbic acid, sugar type derivatives of ascorbic acid, stereoisomers, diastereomers, precursors of these acids and their salts. A co-developer may be particularly useful where physical development of the silver halide particles to form pseudomorphic silver particles is desired. By pseudomorphic silver particles, it is meant silver particles that largely retain the morphology of silver halide particles from which they were formed.

The conversion or development of silver halide particles to silver particles may be made up of features of physical development and/or features of chemical development. Development that is mostly physical development tends to result in pseudomorphic silver particles, whereas chemical development leads to a change in morphology of silver particles (as compared with the silver halide particles).

Optionally, also in order to encourage physical development of the silver halide particles and thereby illicit more control of the size and morphology of the silver particles formed by this method, the developer composition may comprise a fixing agent. The use of a fixing agent in the developer composition is found to be particularly effective in controlling the morphology of the resultant silver particles when the silver halide particles are fogged by raising the pH of the silver halide particle dispersion. Any suitable fixing agent may be used, but preferably sodium sulfite is used.

The fixing agent may be incorporated into the developer composition prior to addition to the fogged silver halide dispersion or, if a dormant (or incorporated) developer composition is present in the silver halide dispersion, by adding the fixing agent to the silver halide dispersion at the time of activation of the developer composition (e.g. when raising the pH of s silver halide dispersion containing ascorbic acid).

The characteristics of the silver particles in the dispersion of silver particles formed according to the present invention may preferably be controlled by choosing appropriate measures in each of the steps involved in preparing the dispersion of silver particles. For example, the morphology of the silver particles formed, the size and size distribution of particles formed in the dispersion and the conductivity of the dispersion may be controlled.

The size, morphology and size distribution may be controlled by controlling the morphology of the silver halide particles provided and/or by controlling the conversion of silver halide particles into silver particles.

In order to control the morphology of silver particles in the dispersion formed, for example to generate large plate-like particles such as tabular silver particles (or silver platelet particles), a silver halide dispersion may be provided which already has the desired morphology, i.e. silver halide particles with large plate-like or tabular structures. The conversion process may then be selected to change or maintain the size and shape of the particles as discussed above.

As mentioned above, another aspect of controlling the morphology of the silver particles formed is to control the conversion of silver halide particles to silver particles. Preferably, for example in order to largely maintain the morphology of the silver halide particles in the silver particles (to form pseudomorphic silver particles), the change in morphology of the silver halide particles on development to form silver particles is minimised so that the control of the size and morphology of the silver particles can effected by simply controlling the size and morphology of the silver halide particles from which they are prepared.

Accordingly, conditions which favour physical development, whereby silver particles which are largely pseudomorphic to corresponding silver halide particles are formed, rather than chemical development are preferred.

In particular, it is preferred to utilise high chloride silver halide particles, preferably 100% silver chloride particles, which are more prone to physical development, to utilise a co-developer such as HMMP, especially when ascorbic acid or derivative is the developing agent, and especially where pH is used to fog the silver halide particles, to use a fixing agent such as sodium sulphite to encourage physical development. These physical development favouring conditions—high chloride silver halide particles, a co-developer, a fixing agent—may be used individually or preferably in combination and most preferably all these conditions are adopted.

The methods of the present invention may be utilised therefore to control the desired size and shape of silver particles depending upon the utility to which they are to be put. The variables described may be changed to form, for example, silver particles in the form of T-grains, cubes, filaments or rods. T-grains, cubes or rods are preferably formed by controlling the formation of silver halide particles to generate silver halide particles having the desired morphology and then controlling the conversion of the silver halide particles to minimize change in the morphology. Filaments and to some degree rods may be formed by controlling the formation of the silver halide particles to encourage crystal growth in the desired dimensions and to control the conversion of silver halide particles to silver particles such that further dimensional extension of the particles arises to form filaments and/or rods, e.g. by utilising conditions that encourage chemical development.

The above factors (and those following) are useful individually or preferably in combination to control the respective degrees of physical and chemical development when forming silver particles from silver halide particles and/or to control the size, size distribution and/or morphology of silver particles.

Preferably, in the method according to the present invention, the provision of a dispersion of silver halide particles in a carrier medium comprises generating a dispersion of silver halide particles in a carrier medium, preferably by precipitating silver halide particles (or grains) from silver ions (e.g. from silver nitrate) and halide ions.

In the following discussion of suitable materials for use in the silver halide dispersions described herein, reference will be made to Research Disclosure. September 1994, Item 36544, (published by Kenneth Mason Publications, Ltd., Dudley Annex, 12a North Street, Emsworth, Hampshire P010 7DQ, ENGLAND), which will be identified hereafter by the term “Research Disclosure”. The contents of the Research Disclosure, including the patents and publications referenced therein, are incorporated herein by reference, and the Sections hereafter referred to are Sections of the Research Disclosure.

Suitable silver halide dispersions (referred to as silver halide emulsions in the photographic arts) and their preparation are described in Sections I through V. Other additives that may be useful in the present invention, such as chemical and spectral sensitisers, antifoggants and coating aids, etc are also described in the Research Disclosure.

As described above, any silver halide combination can be used, such as silver chloride, silver chlorobromide, silver chlorobromoiodide, silver bromide, silver bromoiodide or silver chloroiodide. In cases where the composition comprises a mixed halide, the minor component may be added during crystal formation or after formation during an optional sensitization step. The shape of the silver halide particles or grains can be cubic, pseudo-cubic, octahedral, tetradecahedral or tabular as necessary or desired for the particular utility to which the resulting silver particles are to be put. The particles may be precipitated to form the required dispersion in any suitable environment, such as a ripening environment, a reducing environment or an oxidizing environment.

Specific references relating to the preparation of dispersions or emulsions of differing halide ratios and morphologies are EP-A-1321812, U.S. Pat. No. 3,618,622, U.S. Pat. No. 4,269,927, U.S. Pat. No. 4,414,306, U.S. Pat. No. 4,400,463, U.S. Pat. No. 4,713,323, U.S. Pat. No. 4,804,621, U.S. Pat. No. 4,738,398, U.S. Pat. No. 4,952,491, U.S. Pat. No. 4,493,508, U.S. Pat. No. 4,820,624, U.S. Pat. No. 5,264,337, U.S. Pat. No. 5,275,930, U.S. Pat. No. 5,320,938, U.S. Pat. No. 5,550,013, EP-A-0718679, U.S. Pat. No. 5,726,005 and U.S. Pat. No. 5,736,310, the disclosures of which are incorporated herein by reference.

Silver halide particle precipitation into a dispersion (or emulsion) is conducted in the presence of silver ions, halide ions and in an aqueous dispersing medium typically including, at least during particle or grain growth, a peptizer. Particle or grain structure and properties can be selected by control of precipitation temperatures, pH and the relative proportions of silver and halide ions in the dispersing medium. In preparing photographic silver halide emulsions, precipitation is customarily conducted on the halide side of the equivalence point (the point at which silver and halide ion activities are equal) in order to avoid fog, For the purposes of the present invention, precipitation may be conducted at the equivalence point or at either the halide side or the silver side. Manipulations of these basic parameters are illustrated by the citations including photographic emulsion precipitation descriptions and are further illustrated by U.S. Pat. No. 4,497,895, U.S. Pat. No. 4,728,603, U.S. Pat. No. 4,755,456, U.S. Pat. No. 4,847,190, U.S. Pat. No. 5,017,468, U.S. Pat. No. 5,166,045, EP-A-0328042 and EP-A-0531799. In one embodiment of the invention, the precipitation may be carried out on the silver side of the equivalence point in order to generate fog in the silver halide particles formed.

Reducing agents can be incorporated in the dispersing medium during precipitation and employed to increase the sensitivity of the silver halide particles, as illustrated in U.S. Pat. No. 5,061,614, U.S. Pat. No. 5,079,138, EP-A-0434012, U.S. Pat. No. 5,185,241, EP-A-0369491, EP-A-0371338, EP-A-0435270, EP-A-0435355 and EP-A-0438791. Conversely, oxidizing agents may be incorporated during precipitation, used as a pre-treatment of the dispersing medium (gelatin) or added to the dispersion after silver halide particle formation in order to reduce the propensity of the silver halide to fog or to minimize residual ripening, as illustrated in JP 56-167393, JP 59-195232, EP-A-0144990 and EP-A-0166347. Chemically sensitized core grains can serve as hosts for the precipitation of shells, as illustrated in U.S. Pat. No. 3,206,313, U.S. Pat. No. 3,327,322, U.S. Pat. No. 3,761,276, U.S. Pat. No. 4,035,185 and U.S. Pat. No. 4,504,570.

Addenda such as antifoggants, chemical sensitisers and spectral sensitising dyes that adsorb to the silver halide particle or grain surfaces and may therefore be used to control or inhibit particle growth from one or more surface of the silver halide particles during or after precipitation or to control the effect of development on morphology, may be added to the silver halide dispersions during or after precipitation.

Precipitation in the presence of spectral sensitizing dyes is illustrated in U.S. Pat. No. 4,183,756, U.S. Pat. No. 4,225,666, U.S. Pat. No. 4,683,193, U.S. Pat. No. 4,828,972, U.S. Pat. No. 4,912,017, U.S. Pat. No. 4,983,508, U.S. Pat. No. 4,996,140, U.S. Pat. No. 5,077,190, U.S. Pat. No. 5,141,845, U.S. Pat. No. 5,153,116, EP-A-0287100 and EP-A-0301508. Non-dye addenda are illustrated in U.S. Pat. No. 4,705,747, U.S. Pat. No. 4,868,102, U.S. Pat. No. 5,015,563, U.S. Pat. No. 5,045,444, U.S. Pat. No. 5,070,008 and EP-A-0392092. Water soluble disulfides are illustrated in U.S. Pat. No. 5,418,127.

Effective chemical sensitisers for this purpose include sulfur, sulfur plus gold or gold only sensitisers. Typical gold sensitizers are chloroaurates, aurous dithiosulfate, aqueous colloidal gold sulfide or aurous bis(1,4,5-trimethyl-1,2,4-triazolium-3-thiolate) tetrafluoroborate (e.g. U.S. Pat. No. 5,049,485). Sulfur sensitizers may include thiosulfate, thiocyanate, N,N′-carbothioyl-bis(N-methylglycine) or 1,3-dicarboxymethyl-1,3-dimethyl-2-thiourea sodium salt.

As mentioned above, tabular silver halide particle dispersions may be used in the present invention to form a dispersion of tabular silver particles. Specifically contemplated tabular particle dispersions are those in which greater than 50 percent of the total projected area of the particles are accounted for by tabular grains having a thickness of less than 0.5 μm, preferably 0.3 μm and an average tabularity (T) of greater than 25 (preferably greater than 100), where the term “tabularity” is employed in its art (in photographic silver halide emulsions) recognized usage as

T=ECD/t²

wherein

ECD is the average equivalent circular diameter of the tabular grains in micrometers and

t is the average thickness in micrometers of the tabular grains.

The average useful ECD of photographic emulsions can range up to about 10 μm and as low as can be usefully achieved. Tabular grain thicknesses may range down to about 0.02 μm. However, still lower tabular grain thicknesses are contemplated. For example, Daubendiek et al in U.S. Pat. No. 4,672,027 reports a 3 mol percent iodide tabular grain silver bromoiodide emulsion having a grain thickness of 0.017 μm. Ultrathin tabular grain high chloride emulsions are disclosed by Maskasky in U.S. Pat. No. 5,217,858.

As noted above, tabular particles of less than the specified thickness account for at least 50 percent of the total particle projected area of the dispersion. To maximize the advantages of high tabularity it is generally preferred that tabular grains satisfying the stated thickness criterion account for the highest conveniently attainable percentage of the total grain projected area of the dispersion. For example, in preferred dispersions of tabular particles, tabular particles satisfying the stated thickness criteria above account for at least 70 percent of the total particle projected area. In more preferred tabular particle dispersions, tabular particles satisfying the thickness criteria above account for at least 90 percent of total particle projected area.

Suitable tabular grain emulsions can be selected from among a variety of conventional teachings, such as those of the following: Research Disclosure, Item 22534, January 1983 (published by Kenneth Mason Publications, Ltd., Emsworth, Hampshire P1010 7DD, England), U.S. Pat. No. 4,439,520, U.S. Pat. No. 4,414,310, U.S. Pat. No. 4,433,048, U.S. Pat. No. 4,643,966, U.S. Pat. No. 4,647,528, U.S. Pat. No. 4,665,012, U.S. Pat. No. 4,672,027, U.S. Pat. No. 4,678,745, U.S. Pat. No. 4,693,964, U.S. Pat. No. 4,713,320, U.S. Pat. No. 4,722,886, U.S. Pat. No. 4,755,456, U.S. Pat. No. 4,775,617, U.S. Pat. No. 4,797,354, U.S. Pat. No. 4,801,522, U.S. Pat. No. 4,806,461, U.S. Pat. No. 4,835,095, U.S. Pat. No. 4,853,322, U.S. Pat. No. 4,914,014, U.S. Pat. No. 4,962,015, U.S. Pat. No. 4,985,350, U.S. Pat. No. 5,061,069 and U.S. Pat. No. 5,061,616.

The silver halide dispersions are preferably surface-sensitive, i.e. fog primarily on the surfaces of the silver halide particles

Other components that may be included in the silver halide particle dispersion and/or the silver particle dispersion include nucleating agents, electron transfer agents, development accelerators and surfactants.

Nucleating agents, electron transfer agents and development accelerators may be usefully employed to control the development of silver halide particles into silver particles in terms of development rate (which is a form of control in itself) and/or change in morphology on development, e.g. encouraging development to occur preferentially at one location on or in the silver halide particle and so discourage preferential development elsewhere on the particle.

Suitable nucleating agents, electron transfer agents and development accelerators include, for example, those described in GB-A-2097140, GB-A-2131188, U.S. Pat. No. 4,859,578 and U.S. Pat. No. 4,912,025, the disclosures of which are incorporated herein by reference.

The concentration of silver in the dispersion of silver particles may vary depending upon the carrier material and the method by which the silver particles are formed from silver halide particles. Where silver particles are formed from silver halide particles in gelatin, it is preferable, especially for use in coating as a conductive coating or to aid the removal of the carrier medium, that the silver to gelatin ratio is such that there is 60 g or less per silver mole, more preferably 40 g or less and still more preferably 20 g or less.

Furthermore, although the size, shape and size distribution of the silver particles can be controlled by the method of the present invention, depending upon the desired utility and the limitations of the apparatus used to handle the silver particles, and without implying undue limitation, it is preferred that various features of the silver particles' morphology are controlled as follows. It is preferred to have a larges dimension of up to 10 μm, e.g. in the range 0.1 to 10 μm, more preferably from 0.25 to 5 μm. Whilst the particles shape can be controlled as discussed above, it is beneficial to provide silver particles having a tabular morphology, which may be, for example, tabular [100] particles (roughly rectangular) or tabular [111] (roughly hexagonal), or a mixture thereof. By tabular [100] and [111] silver particles, it is meant silver particles that have been formed in a pseudomorphic manner from or have a similar morphology to tabular [100] and [111] silver halide particles. The tabular silver particles preferably have an aspect ratio of at least 3:1, more preferably at least 5:1 and still more preferably in the range of from 10:1 to 50:1. Tabular silver particles according to the invention are also preferably up to 0.5 μm thick and more preferably up to 0.2 μm thick, thereby encouraging a good deal of overlap between particles when utilised in the various applications.

A particular advantage of the present invention is the ability to control the size distribution of silver particles formed, whether cubic, tabular or of other morphology, without the need to develop clumsy particle filters to sort particle sizes. For example, to enable the largest possible silver particles to be used as a conductive ink (thereby providing maximum conductivity) via ink-jet printing, whilst minimising the risk of blocking the ink-jet head with larger particles, it is beneficial to control the formation of silver particles to within certain parameters. The most attractive method of achieving that according to the present invention is to generate a narrow size distribution of silver halide particles and convert them to silver particles utilising conditions that most favour physical development or pseudomorphological conversion.

Preferably, according to the present invention, the dispersion of silver particles is controlled to have a size distribution with a coefficient of variation (COV) of up to 0.5, more preferably up to 0.4, still more preferably up to 0.25, still more preferably up to 0.2 and most preferably up to 0.15. In ideal circumstances, it is foreseen that a COV of 0.1 would be most preferred.

The COV is an attribute of distribution and can be calculated as the standard deviation divided by the mean (and is sometimes quoted as a percentage). The COV of the size distribution, in this case, is based upon the relative count of particles according to their volume. In this regard, the COV accounts for variations not only in the size of particles but also in volume, such that a low COV is achieved with uniformity of size and shape.

The various possible preferred physical features of the silver particles may be appropriate individually or preferably in combination, depending upon the utility to which the silver particles are put, but may be expanded upon in the different embodiments discussed below.

In one embodiment of the invention, the conductive silver dispersion may be utilised as a coatable conductor for coating onto a substrate, either in a layered format to generate a conductive layered coating or in a patterned format to generate a conductive patterned coating. Applications for such conductive coatings include a conductive back-plate for an electronic device such as a printed circuit board or an electronic display device, radio frequency (RF) or electromagnetic shields for devices such as mobile telephones and laptop computers, and as the circuitry on printed circuit boards or flexible printed circuits.

A dispersion of silver particles for forming conductive coatings may comprise a polymer binder material as the carrier material and suitable such binder materials include those polymeric binders referred to above as suitable carrier materials. Preferably, for the purpose of forming either a conductive layered coating or a conductive patterned coating, the dispersion comprises a hardener to cause the coating to harden once dried on the substrate, especially where gelatin or similar polymeric binder is utilised. Suitable such hardeners are those common in photographic materials and are described in the above-referenced Research Disclosure.

Alternatively, the carrier medium comprises, or more preferably consists essentially of, partially silylated (meth)acrylate copolymers, such as those described in U.S. Pat. No. 6,558,746, preferably in an aqueous medium, in order to provide coatings on drying which have excellent adhesive strength, mechanical resistance and resistance to solvents a co-polymer of such as those described above. Typical silylated co-monomers include, for example, methacryloxypropyl trimethoxysilane and vinyl trimethoxy silane. Preferably, the copolymer has a degree of silylation of 0.05 to 50% and are readily dispersible in water. A typical copolymer is composed, for example, of 45% methylmethacrylate, 50% n-butylacrylate and 5% methacryloxypropyl trimethoxysilane.

Optionally, the silver dispersions used in forming the conductive coatings comprise other conductive pigments such as silver flake powders, copper flake powders, metallized inorganic flake pigments and powders of conductive inorganic oxides such as fluoride-doped tin oxide or indium/tin oxide.

Further additives that may optionally be incorporated into the silver particle dispersion include wetting agents, defoaming agents, adhesion promoters, cross-linking agents and combinations thereof as desired.

Preferably, the silver particle dispersion according to this embodiment has a composition comprising 2.5 to 10% carrier material, 25% to 75% silver particles and optional additional conductive pigment, 13 to 72.5% water, 0 to 3% further additives and 0 to 0.5% organic solvent.

The morphology of the silver particles used in accordance with this embodiment of the invention whereby the dispersion of silver particles is used as a conductive coating can be any shape, e.g. tabular, cubic, filament, rods and of any size and size distribution. Preferably, however, tabular silver particles are used, both for the layered and the patterned conductive coatings. For layered conductive coatings, it is believed that the improved conductivity and ability to provide thin layered materials is beneficial. For patterned conductive coatings, especially for use as conductive tracks, it is believed that alignment of tabular silver particles along a desired conductive track pattern is capable of providing improved conductivity through having larger conductive silver particles and through the ability of such particles to abut and overlay one another effectively to improve the contact and therefore the conductivity at a comparatively low silver laydown.

Preferably, the aspect ratio of the tabular silver particles preferred according to this embodiment is at least 3:1, more preferably at least 5:1 and most preferably in the range of form 10:1 to 50:1. The tabular silver particles more preferably have a larger dimension of from 0.1 to 10 μm, still more preferably from 0.25 to 5 μm. Still more preferably, the tabular silver particles are up to 0.5 μm thick and still more preferably up to 0.05 μm thick.

In forming the conductive layered coating, a silver dispersion may be applied to a substrate by any suitable method, such as by spraying, dipping the substrate into a bath of the dispersion or roll-to-roll coating including bead coating, curtain coating.

In a preferred aspect of this embodiment, the conductive silver dispersion may be utilised as a patterned conductive coating providing, for example, conductive tracks on a substrate. In order to generate a pattern of a conductive silver dispersion, the dispersion may be coated onto the substrate in a manner whereby a pattern is formed. For example, a patterned coating of a conductive silver dispersion may be generated by utilising the method of our co-pending patent application directed toward continuous discrete coating and described in International Patent Application No. PCT/GB2004/002591. According to this preferred feature of this embodiment in which the silver dispersion may be coated in a patterned manner to form, for example, conductive tracks, the substrate upon which the silver dispersion is to be coated, which is preferably a flexible substrate, is treated such as to generate a surface pattern defining lyophilic (solvent loving) and lyophobic (solvent hating) areas corresponding to a desired pattern such that on application of a coating of the silver dispersion in a chosen carrier medium, the dispersion recedes from the lyophobic areas to the lyophilic areas to generate a patterned conductive track corresponding to the desired pattern.

In another embodiment, the silver dispersion may utilised as a conductive ink. The conductive ink may be an ink suitable for any one or more of, for example ink-jet, flexographic, lithographic, gravure, intaglio and screen printing. The conductive ink may be suitable for any suitable conductive ink application including, for example, in fabrication of electronic components, conductive tracks in printed circuit boards, semi-conductors, through-hole interconnectors, multi-layer ceramic capacitors, conductive tapes, flexible electronics, RFID tag antenna, arrays of contacts for display technologies, electrodes for biological and electrochemical sensors, smart textiles etc.

For use in conductive track formation and most other conductive ink applications in electronics, it is preferred that tabular silver particles are utilised. It is believed that improved conductivity with tabular silver particles arises from having fewer inter-particle connections and, since tabular silver particles tend to overlay to a degree, good and effective inter-particle connections.

The preferred ink composition depends to some degree upon the printing method and the application.

For example, a conductive ink for use in lithographic printing of, for example, an electronic circuit, preferably comprises tabular silver particles, which may have an average particle size of from 1 to 10 μm, preferably 4 to 6 μm. Preferably, the aspect ratio of the tabular silver particles is at least 3:1, more preferably at least 5:1 and most preferably in the range of form 10:1 to 50:1. The tabular silver particles may be up to 0.5 μm thick and still more preferably up to 0.05 μm thick. Optionally, such a conductive ink may further comprise one or more types of smaller silver particles of the same or different morphology, e.g. cubic, to improve the inter-particle connectivity. The tabular particles are particularly beneficial for lithographic printing where high conductivity with low laydown of silver is attractive.

For ink-jet printing, the size and morphology of the silver particles used is dependent upon the desired application, etc., but is limited by the dimensions of the ink-jet printing head. Whilst, for some applications, large flat tabular particles may be beneficial, it may be difficult to achieve laydown of such particles via an ink-jet method using a small aperture ink-jet head. It is preferred therefore, for a conductive ink that the size of the particles are chosen according to the size of the ink-jet head, e.g. smaller tabular particles (e.g. having a larger dimension of up to 1 μm), but preferably cubic particles are utilised in a conductive ink-jet ink, the size being chosen according to the application and the size of the aperture of the ink-jet head. The method of the invention may advantageously be used in ink-jet conductive inks by controlling the size distribution of particles accurately and thereby increasing the average size of silver particles that may be used and thereby increasing the conductivity, without increasing the risk of blocking the ink-jet head. The size distribution can be controlled by selecting parameters that favour physical development of silver halide particles as discussed above and by utilising well-established methods for controlling the size distribution in preparing a dispersion of silver halide particles. Preferably, for this purpose, the coefficient of variation of particle sizes in the silver particle dispersion according to the invention is up to 0.5, more preferably up to 0.25 and still more preferably up to 0.2 or less.

It is anticipated that, whilst the cost of manufacture of electronics in which conductive inks are used is generally quite high, it is likely that through improved manufacturing techniques and large-scale manufacture of flexible electronics the cost of such devices will reduce. In this event, the cost of the silver laydown, which is presently relatively insignificant, will become significant and the ability through the methods of the present invention to provide improved conductivity with a lower silver laydown will be a significant advantage. Furthermore, improved conductivity at a lower silver laydown coupled with the control of size distribution etc., will enable more complex devices and circuits to be prepared using conductive inks, e.g. using ink-jet printing.

The conductive inks may be prepared by dispersing the silver particles in a suitable ink-dispersant. This may be achieved by converting the silver halide particles to silver particles in a carrier medium that is suitable for use as an ink-dispersant, using a carrier medium that when co-dispersed with another material forms a suitable ink-dispersant or displacing the carrier medium in which the silver halide particles are converted to silver particles with an ink-dispersant. Optionally, the preparation of silver particles from silver halide particles may be formed in a carrier medium that is also useful as an ink dispersant.

Suitable ink-dispersants depend upon the application but may include a high-boiling solvent and a binder either as two or more separate components or as a single component. Other components for use in conductive inks include, for example, an anti-oxidant, a drying agent, a tack-reducing agent, a thickener, a hardener and a surfactant.

The binder may be, for example in lithographic printing, a hydrocarbon resin containing an alkyd resin, including styrenated alkyd resin, a carboxylic acid- or anhydride-functional aromatic vinyl polymer such as described in WO-A-03/068874 for use in flexographic or gravure printing, a thermal curable resin system comprising of for example an admixture of an expoxy resin, a cross-linking agent and a catalyst such as described in U.S. Pat. No. 6,332,620 for use as a thermoset conductive ink.

The formulation of conductive inks according to the present invention may be as typical in the art of conductive inks and would be within the normal capabilities of the skilled person in the art.

In another embodiment, the silver dispersion may be utilised as a conductive filler material. The silver dispersion may be used as conductive filler materials in a polymer material to provide electromagnetic (EMI) and radiofrequency (RF) shielding, conductivity and heat transfer capabilities in, for example, elastomers, sealants, adhesives, coatings, tapes and EMI gaskets for a range of applications including, for example, electronic enclosures, computer enclosures, cell phones, hand-held devices, network routers, medical diagnostic and analytical equipment, aerospace and automotive equipment, conductive sheets, aerospace sealants, conductive greases, conductive adhesives and epoxy, anisotropic connectors and anisotropic adhesives.

The silver particles of the invention for use as conductive filler may be any desired size, morphology and size distribution controlled according to requirements by the above methods. The silver particles may be redispersed in an alternative carrier material, depending upon the application to which the conductive filler is to be put. For example, the silver particles may be dispersed in an organosilicon compound such as a polyorganosiloxane or a organohydrogensiloxane, examples of which can be found in U.S. Pat. No. 6,797,772.

The substrate upon which the silver particle containing conductive inks and/or conductive coating are applied depends upon the intended utility. The inks and coatings may be applied to any suitable substrate, pre-coated or otherwise and the substrate may be rigid or flexible but is preferably flexible. Suitable such substrates include rigid, glass-reinforced epoxy laminates, metal pads and semiconductor components, adhesive coated polymer substrates, printed circuit board (PCB) substrates including polymer based PCBs, ceramic substrates, polymer tapes (e.g. dielectric green tape for multi-layer ceramic devices), paper, gloss art paper, bond paper, semi-synthetic paper (e.g. polyester fibre), synthetic paper (e.g. Polyart™), resin coated paper, polymer substrates and composite materials. Suitable polymers for use as polymer substrates include polyethylene, polypropylene, polyester, polyamide, polyimide, polysulfone and mixtures thereof. The substrate, especially a polymer substrate, may be treated to improve adhesion of the ink to the substrate surface. For example, the substrate may be coated with a polymer adhesive layer or the surface may be chemically treated or subjected to a corona treatment.

For coating or printing onto a substrate in the manufacture of flexible electronic devices or components, the support is preferably flexible, which aids rapid roll-to-roll application. Optionally, according to a preferred embodiment of the invention, the support is a porous substrate, which may be a paper, synthetic paper, resin coated paper or porous polymer substrate, e.g. an inkjet paper, which porous substrates have the benefit of drawing the coating composition or ink into the support substrate and thereby improving the contact between silver particles increasing the conductivity.

This invention will now be described in more detail, without limitation, with reference to the following Examples and Figures.

### EXAMPLES

### Example 1

An emulsion (dispersion) of 100% AgCl cubic particles was prepared by double-jet precipitation under controlled flow and pAg conditions of 3M AgNO₃ and NaCl solutions into a reaction vessel held at 75° C. containing 240 g regular bone gelatin, 1.5 ml PLURONIC® 31R1 (an Oxirane, methyl-, polymer) and made up to 6.9 litres with demineralised water. This solution was adjusted to pAg 6.8 with KCl. The initial AgNO₃ solution flow was 32 ml/min for 2.5 minutes, which was subsequently ramped to 200 ml/min over the course of 25 minutes. Flow was then held at 200 ml/min until 4 litres of AgNO₃ solution had been consumed. The resultant particles had an edgelength of 0.54 μm with a narrow size spread (Coefficient Of Variation 0.22) as measured by electrolytic grain analysis.

The resultant emulsion/dispersion was UF washed to remove unwanted reaction by-products to a solution conductivity<10 mS, pAg 6.8 and a pH of 5.6 (UF=ultrafiltration through membrane). An additional quantity of 20 g gelatin per mole equivalent of silver was added after the washing step.

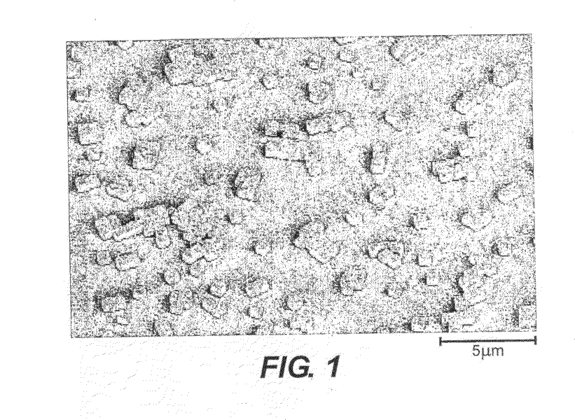

An SEM (Scanning Electron Micrograph) image of the cubic silver chloride particle dispersion was obtained using a diluted sample of the dispersion and is shown in FIG. 1.

A developer composition (1 litre) was prepared as follows:
50.0 g sodium erythorbate (developer)
3.0 g HMMP (developer)
8.0 g sodium thiosulphate (fix)
20 g K₂CO_{3 (buffer)}
Add 900 ml demineralised water, adjust pH to 11.5 with BAS-2013 top up to 1000 ml with demineralised water

A portion (comprising 2 moles silver chloride) of the silver chloride emulsion/dispersion in gelatin held at 40° C. was treated with sodium hydroxide to adjust the pH of the emulsion to 12 in order to fog the silver chloride particles. The fogged emulsion was immediately added (rapidly over approximately two seconds in red light) to a kettle containing 15 litres of the developer composition also held at 40° C. and stirred at a high rate using a prop-stirrer. The contents of the kettle went grey within two to three seconds. The pH was maintained over 10 by careful addition of sodium hydroxide solution during the initial stages of the development of the fogged silver chloride particles (about 3 minutes) and then the pH was adjusted back to 11 for a further 10 minutes. The resultant silver particles were UF washed and concentrated to a solution conductivity of <20 mS by means of an ultrafiltration device. The silver concentration of the resultant silver dispersion was measured to be 0.80 Agmol/kg by ICP (Inductively Coupled Plasma spectroscopy).

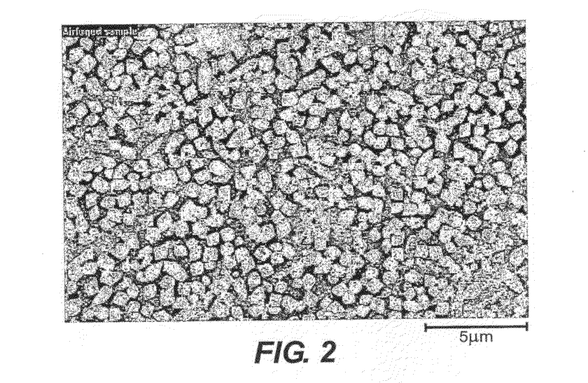

An SEM image of a diluted sample of the silver dispersion formed was obtained and is shown in FIG. 2. On a qualitative comparison between FIGS. 1 and 2, it is apparent that the silver particles have been formed by a pseudomorphic (development) process (i.e. they have largely retained the shape of the silver chloride particles from which they were formed).

### Example 2

An emulsion (dispersion) of 100% AgCl tabular [100] particles was precipitated using a double jet method, starting with 1 M AgNO₃ and NaCl solutions and pumping under controlled pAg conditions at 78 ml/min into a reaction vessel containing 195 g of oxidised gelatin and 4373 g of demineralised water held at 35° C. and a pAg of 7.6 for 1.6 minutes. At this point a solution at 35° C. and containing 2.25 g NaCl and 0.57 g KI and made up to 9.285 litres was added to the reaction vessel and held for 5 minutes. At this point, growth was continued using 4M AgNO₃ and NaCl solutions added at 15 ml/min under controlled pAg conditions. The temperature was increased linearly from 35° C. to 70° C. over 40 minutes. Flows were then stopped for 15 minutes and resumed for a further 45 minutes during which time the flow rate was linearly increased from 15 to 42.3 ml/min, at which point 8 moles of silver were consumed. The emulsion was left to stand for a further 30 minutes at 70° C., before being cooled to 40° C. and washed.

The resultant emulsion/dispersion was UF washed to remove unwanted reaction by-products to a solution conductivity<10 mS, pAg 6.8 and a pH of 5.6. An additional quantity of 20 g gelatin per mole equivalent of silver was added after the washing step.

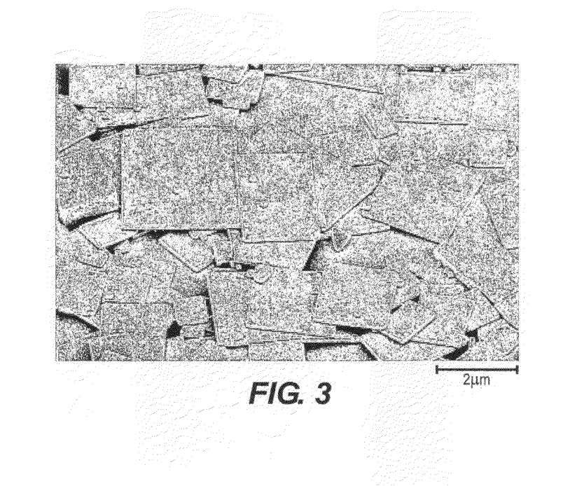

The [100] tabular silver halide particles formed are evident in the SEM image obtained and shown as FIG. 3.
A developer composition was prepared as follows:
50.0 g sodium erythorbate (developer)
3.0 g HMMP (developer)
8.0 g sodium thiosulphate (fix)
20 g K₂CO_{3 (buffer)}
Add 900 g Dmin water, adjust pH to 11.5 with BAS-2013 top up to 1000 ml with Dmin water

A portion (comprising 2 moles silver chloride) of the silver chloride emulsion/dispersion in gelatin held at 40° C. was treated with sodium hydroxide to adjust the pH of the emulsion to 12 in order to fog the silver chloride particles. The fogged emulsion was immediately added (rapidly over approximately two seconds in red light) to a kettle containing 15 litres of the developer composition also held at 40° C. and stirred at a high rate using a prop-stirrer. The contents of the kettle went grey within two to three seconds. The pH was allowed to drop to 9.7 over the first 3 minutes and then adjusted back to 11 for a further 10 minutes. The resultant silver particles were UF washed and concentrated to a solution conductivity of <20 mS by means of an ultrafiltration device. The silver concentration of the resultant silver dispersion was measured to be 0.83 Agmol/kg by ICP (Inductively Coupled Plasma spectroscopy).

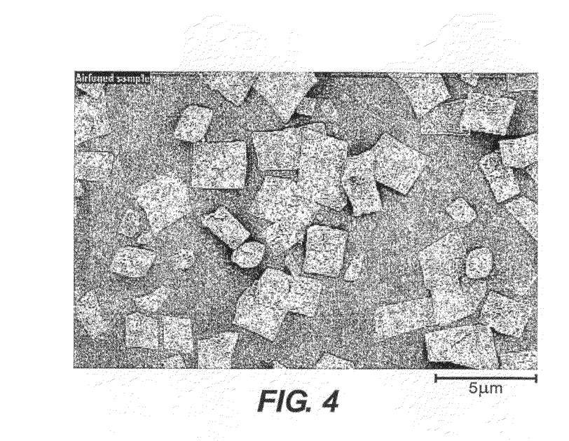

FIG. 4 shows an SEM image of the silver particles formed, which are clearly tabular [100] silver particles. Again, by comparison with the silver chloride particles shown in FIG. 3, it is clear that the silver particles largely retain the shape of the silver chloride particles from which they are formed. By comparison o the silver particles formed in Example 2 (FIG. 4) with those formed in Example 1 (FIG. 2), it is apparent that the size and shape of silver particles formed can be accurately controlled by controlling the size and shape of the silver chloride particles from which they are formed. Furthermore, quite diverse size and shape characteristics can be controllably achieved. In Example 1, cubic silver particles (FIG. 2) are formed having an edgelength of between 0.5 and 1 μm (qualitative)—0.54 μm as measured, whereas in Example 2, [100] tabular silver particles (FIG. 4) are formed having a longer edge-length of 3-4 μm (qualitative).

### Example 3

An emulsion (dispersion) of 100% AgCl tabular [111] particles was precipitated in the presence of adenine, using the method described in Example 1 of U.S. Pat. No. 5,176,991 (C. G. Jones et. al.) minus the coagulation washing step.

The resultant emulsion/dispersion was UF washed to remove unwanted reaction by-products to a solution conductivity<10 mS, pAg 6.8 and a pH of 5.6.

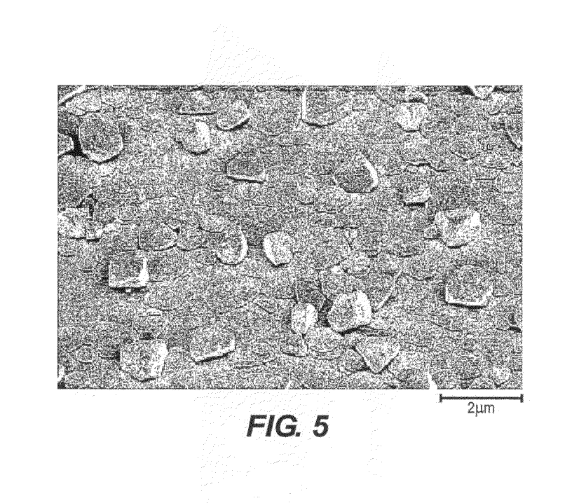

An SEM image (FIG. 5) shows a sample of the roughly hexagonal [111] tabular silver chloride particles obtained.

A developer composition was prepared as follows:
50.0 g sodium.erythorbate (developer)
3.0 g H (developer)
4.0 g sodium thiosulphate (fix)
20 g K₂CO₃ (buffer)
Add 900 g Dmin water, adjust pH to 11.5 with BAS-2013 top up to 1000 ml with Dmin water

A portion (comprising 0.07 moles silver chloride) of the silver chloride emulsion/dispersion in gelatin held at 40° C. was treated with sodium hydroxide to adjust the pH of the emulsion to 12 and held at pH 12 for 10 minutes in order to fog the silver chloride particles. A composition comprising 240 ml of the developer composition and 70 ml of 100 g/l sodium hydroxide solution, held at 40° C. was added to the silver chloride emulsion in order to maintain a high pH during development. The pH was reduced to 5.3 after 5 minutes and 0.2 ml of Surfonyl™ CT131 surfactant to aid dispersement of the resulting silver particles. The silver dispersion was left to stand for 24 hours and 90% of the supernatant decanted.

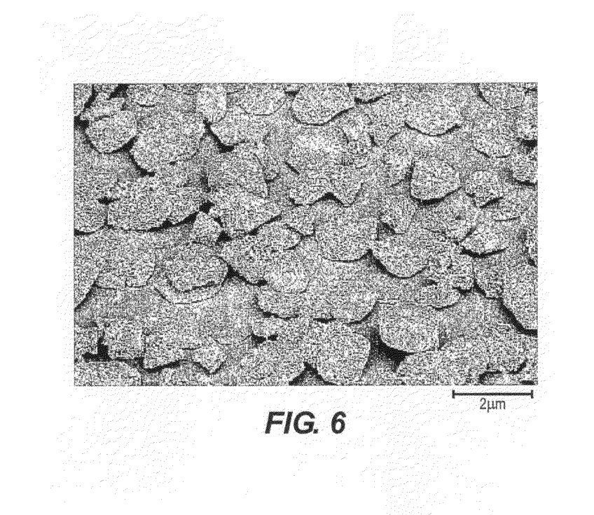

FIG. 6 shows an SEM image of the [111] tabular silver particles formed, which as can be seen by comparison with FIG. 5 have been pseudomorphically reduced from silver chloride particles by the method of the invention.

### Example 4

An emulsion (dispersion) of 100% silver chloride tabular [100] particles was prepared according to the method described in Example 2 above.

A developer composition was prepared as follows:
50.0 g sodium.erythorbate (developer)
3.0 g HMMP (developer)
4.0 g sodium thiosulphate (fix)
20 g K₂CO₃ (buffer)
Add 900 g Dmin water, adjust pH to 11.5 with BAS-2013 top up to 1000 ml with Dmin water

A portion (comprising 0.1 moles silver chloride) of the silver chloride emulsion/dispersion in gelatin held at 40° C. was treated with 0.2 ml of an SnCl₂ solution (10 μl) in 0.6 M HCl and held for 10 minutes in order to fog the silver chloride particles. 240 ml of developer solution and 70 ml of 100 g/l sodium hydroxide solution to maintain a high pH during development, were added to the emulsion at 40° C. The pH was reduced to 5.3 after 5 minutes and 0.2 ml of Surfonyl™ CT131 surfactant to aid dispersement of the resulting silver particles. The silver dispersion was then centrifuged several times in order to wash and concentrate the dispersion.

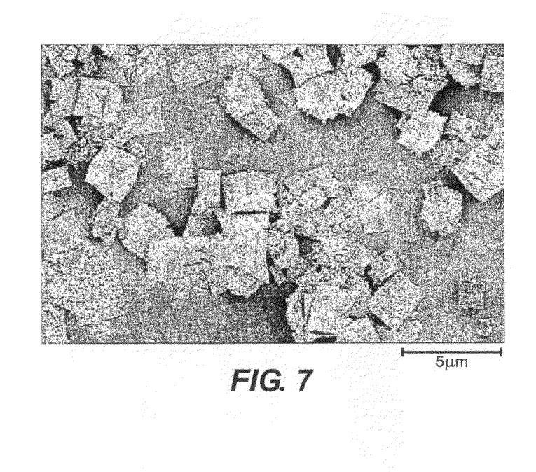

FIG. 7 shows an SEM image of the silver particles formed, which are clearly recognisable as [100] tabular particles, which again have largely retained the shape of the silver chloride particles from which they have been formed (see FIG. 3).

### Example 5

Samples of the silver dispersions prepared according to Examples 1-4 (Dispersions 1-4 respectively) were coated onto various supports, such as Estar® polyethylene base, and ink-jet media as well as other paper types using an RK automated bar coater using 24 μm and 40 μm coating bars. The porous ink-jet media had a greater coated silver laydown (measured using XRF) due to the substrate absorbing liquid as the coating bar was traversing the sample.

The resistivity across a 31 mm disc was measured for each coated sample (measurements were repeated four times across different axes and averaged). The silver laydown and resistivity (in ohms per square) for each sample are shown in Table 1.

TABLE 1
Silver laydown and Resisitivity of coated samples of Dispersions 1-4

| | | | | Ag | Resisivity |
|---|---|---|---|---|---|
| | | | Coating bar | Laydown | (ohms/ |
| Coating | Substrate | Dispersion | (μm laydown) | (mg/m²) | square) |
| A | ESTAR ® | 2 | 40 | 5225 | 11.5 |
| B | Porous | 2 | 24 | 3281 | 23.5 |
| | Receiver | | | | |
| C | Porous | 2 | 40 | 4387 | 16.5 |
| | Receiver | | | | |
| D | Micro | 1 | 24 | 2528 | 390 |
| | Porous IJ | | | | |
| | Paper | | | | |
| E | Porous | 1 | 40 | 4379 | 38.5 |
| | Receiver | | | | |
| F | ESTAR ® | 3 | Blade | 8894 | 18 |
| G | Gloss Art | 3 | Hand spread | 7994 | 10.4 |
| | Paper | | | | |
| H | Porous | 4 | 24 | 8745 | 8.1 |
| | Receiver | | | | |

“Microporous IJ Paper” is Kodak Instant Dry Photographic Ink-Jet Paper, microporous alumina based receiver with 30 nm pore size.
“Porous receiver” comprised calcium carbonate particles (average diameter 0.7 μm) coated with PVA and surfactant on a porous paper.

This demonstrates that the various silver dispersions can be used to form conductive coatings on a range of supports. Predictably, a greater laydown of silver can be shown to give better conductivity (see coatings B and C). It is apparent on comparison of coatings C and E that the bigger, flatter [100] tabular silver particles give better conductivity on a porous support than cubic silver particles for a similar laydown.

### Example 6

### Flexo Printing

A 60 g sample of the silver dispersion prepared in Example 2 above was further concentrated by means of spinning down in a centrifuge at 3000 RPM at 40° C. for 10 minutes. 45 g of supernatant liquid was removed to leave a material which was in the order of 3.33 Agmol/kg. The sample was redispersed by manual stirring and using a soni-probe for 5 minutes and then printed onto various substrates using an RK Flexo proofer with anilox roller at 2001 pi. Both patterned and unpatterned rollers were used. Results for the patterned roller showed that material could be used to flexo print. Results for the unpatterned roller provided XRF and resistivity measurements (across a 31 mm disc) as detailed in Table 2 below. As with some commercially available conductive Flexo inks, it was necessary to lay down more than one layer of ink to yield satisfactory conductivity and the table highlights conductivity of 2 and 3 impressions on top of each other.

TABLE 2

| | | | Silver | |
|---|---|---|---|---|
| | | | Laydown | Resistivity |
| Coating | Substrate | Impressions | (mg/m2) | (ohms/square) |
| I | ESTAR ® | 2 | 2388 | 3100 |
| J | ESTAR ® | 3 | 3173 | 312.5 |
| K | Gloss-art | 2 | 1962 | 12500 |
| | paper | | | |
| L | Gloss-art | 3 | 3446 | 335.5 |
| | paper | | | |
| M | Plain paper | 3 | 3577 | 622,000 |

### Example 7

### Ink-Jet Printing

A silver dispersion prepared according to the method in Example 1 was treated with 2% by volume of a surfactant solution comprising 71.8 g/kg ethanesulfonic acid, 2-(2-(2-(4-(1,1,3,3-tetramethylbutyl)phenoxy)ethoxy)ethoxy)-, sodium salt and mixed at 30° C. immediately prior to printing. The dispersion was jetted onto various substrates using a valve-jet device, such as that described in US-A-2004/0110101. The printing of lines of dots as well as block areas using this method was demonstrated. Silver laydown and conductivity (as resistivity across a 31 mm disc) of block-printed silver were measured for a range of nozzle diameters on each substrate. The results are set out in Table 3.

TABLE 3
Silver laydown and resistivity following ink-jet application

| | | Nozzle | Printed | Resistivity |
|---|---|---|---|---|
| | | diameter | Silver | (ohms/ |
| Coating | Substrate Printed | (μm) | (mg/m²) | square) |
| N | Micro Porous IJ Paper | 150 | 4369 | 53 |
| O | Micro Porous IJ Paper | 300 | 5028 | 193 |
| P | Resin coated Paper | 150 | 7654 | 44 |
| Q | Resin coated Paper | 200 | 6005 | 345 |
| R | Resin coated Paper | 300 | 6521 | 142 |

The results show that conductive layers of silver can be prepared by ink-jet printing of silver dispersion made according to the present invention.

1. A method of manufacturing a conductive ink, a conductive filler and/or a conductive coating, which conductive, ink, conductive filler and/or conductive coating comprises particles of silver for imparting conductivity, alone or in combination with another conductive material, said method comprising the steps of
providing a dispersion of silver halide particles in a carrier medium;
treating said dispersion of silver halide particles such that the silver halide particles are converted into silver particles to form a dispersion of silver particles in a carrier medium; whereby said treating is carried out in a manner such that the size, size distribution and morphology of said silver particles can be controlled; and
further processing said dispersion of silver particles in a carrier medium to form a conductive ink, a conductive filler and/or a conductive coating.

2-3. (canceled)

4. A method as claimed in claim 1, wherein said silver halide particles comprise silver chloride in an amount of at least 80%.

5. A method as claimed in claim 1, wherein said dispersion of silver particles comprises silver particles having a dimension in one direction in the range 0.03 to 10 μm.

6. (canceled)

7. A method as claimed in claim 1, wherein the silver halide particles are silver halide tabular grains, and the silver particles having a morphology corresponding substantially to that of said silver halide tabular grains and have an aspect ratio of at least 5:1.

8-11. (canceled)

12. A method as claimed in claim 1, wherein said treatment of said dispersion of silver halide particles comprises fogging said silver halide particles and reducing the fogged silver halide particles with a developer composition.

13. A method as claimed in claim 12, wherein said fogging of said silver halide particles is through treatment with a reducing agent, by exposing said silver halide particles to radiation to which they are sensitive, by adjusting the pH of the silver halide dispersion and/or by incorporating silver ions or a source of silver ions in said dispersion of silver halide particles.

14. (canceled)

15. A method as claimed in claim 1, wherein the carrier medium of the dispersion of silver halide particles comprises a first carrier medium, and the carrier medium of the formed dispersion of silver particles initially also comprises the first carrier medium, and which further comprises substituting the first carrier medium of the dispersion of silver particles for a second carrier medium, different from said first carrier medium.

16-18. (canceled)

19. A method as claimed in claim 1, in which said conductive ink is suitable for inkjet printing and said step of further processing comprises formulating said dispersion of silver particles for use in inkjet printing, wherein said dispersion of silver particles comprises silver particles having a largest dimension of up to 1 μm and having a cubic or tabular morphology, said dispersion having a size distribution with a coefficient of variation of up to 0.5.

20-21. (canceled)

22. A method as claimed in claim 1, which is a method of manufacturing a patterned conductive coating wherein said further processing comprises the steps of treating a support to generate lyophilic and lyophobic areas defining a desired pattern of conductive tracks and coating said dispersion of silver particles onto said support in a laydown of silver particles sufficient to provide a conductive coating, whereby conductive tracks of said silver particles are formed in accordance with said desired pattern.

23. (canceled)

24. A conductive ink, a conductive filler or a conductive coating obtainable by the method of claim 1.

25-28. (canceled)

29. A method of manufacturing a silver dispersion for use as or in the manufacture of a conductive ink, a conductive filler and/or a conductive coating, said method comprising the steps of
providing a dispersion of silver halide particles in a carrier medium; and
treating said dispersion of silver halide particles such that the silver halide particles are converted into silver particles to form a dispersion of silver particles in a carrier medium, whereby said treating is carried out in a manner such that the size, size distribution and morphology of said silver particles can be controlled;
said method characterised by said dispersion of silver particles having one or more of the following features:
A) a coated conductivity represented by a resistivity of up to 1000 ohms per square;
B) at least 50% tabular silver particles having an aspect ratio of at least 3:1; and
C) a size distribution of particles with a coefficient of variation of up to 0.4.

30-31. (canceled)

32. A dispersion of silver particles for use as or in the manufacture of conductive inks, conductive fillers and/or conductive coatings, said dispersion of silver particles comprising silver particles dispersed in a carrier medium in a concentration capable of imparting conductivity represented by a resistivity of 1000 ohms per square or less to said inks, fillers and/or coatings formed therefrom, wherein said silver particles have a tabular morphology and an aspect ratio of at least 3:1 and/or said silver dispersion has a size distribution of silver particles with a coefficient of variation of up to 0.5.

33. A method of manufacturing an electronic circuit comprising the steps of applying a dispersion of silver particles as claimed in claim 32 to a support in a desired pattern of conductive tracks.

34-40. (canceled)

41. A method as claimed in claim 1, wherein the size, size distribution and/or morphology of said silver particles are controlled by treating the dispersion of silver halide particles such that it is converted into a dispersion of silver particles under conditions that favour physical over chemical development.

42. (canceled)

43. A method as claimed in claim 29, wherein the size, size distribution and/or morphology of said silver particles are controlled by treating the dispersion of silver halide particles such that it is converted into a dispersion of silver particles under conditions that favour physical over chemical development.

44. A method as claimed in claim 29, wherein said dispersion of silver particles comprises at least 50% tabular silver particles having an aspect ratio of at least 3:1 and a size distribution of particles with a coefficient of variation of up to 0.4.
